(19) United States
(12) Patent Application Publication
(10) Pub. No.: US 2021/0220929 A1
(43) Pub. Date: Jul. 22, 2021

(54) Device and method for cooling a cross-cutting shear in hot strip mills

(71) Applicant: SMS group GmbH, Düsseldorf (DE)

(72) Inventors: Oliver Larsen FREUND, Freudenberg-Bühl (DE); Bernhard EHLS, Hilchenbach (DE)

(73) Assignee: SMS group GmbH, Düsseldorf (DE)

(21) Appl. No.: 16/769,017

(22) PCT Filed: Nov. 26, 2018
(86) PCT No.: PCT/EP2018/082494

§ 371 Date: Jun. 2, 2020

(30) Foreign Application Priority Data
Dec. 4, 2017 (DE) 10 2017 221 764.2

(51) Int. Cl. B23D 25/12; B23D 33/02

(52) U.S. Cl. CPC B23D 25/12; B23D 33/02

(57) ABSTRACT

A device (100) and a method for cooling a knife-bearing element (102.1, 102.2) of a cross-cutting shear (103), which is in particular installed in a hot rolling mill, are described. When the knife-bearing element (102.1, 102.2) is at standstill, at least one guard device (105) is positioned in a cooling position (K) between the knife-bearing element (102.1, 102.2) and a roll strip (101) running continually through the roller mill, such that a side of the knife-bearing element (102.1, 102.2) opposite the roll strip is shielded by the guard device (105).

### TECHNICAL FIELD

The invention relates to a device for cooling at least one knife-bearing element of a cross-cutting shear installed in a rolling mill, in particular in a hot rolling mill, and a corresponding cooling method.

### BACKGROUND

Shears for cross-cutting a roll strip, for example in a hot rolling mill, are generally known. Such shears can be designed as drum shears, as described, for example, in DE 199 53 906 A1 or DE 100 01 928 A1. Other types of shears include gate shears, crank shears, etc.

If a shear is not cutting, it is at a standstill. Then, the roll strip runs through the shear and heats up the areas of the shear adjacent to the roll strip. In particular, the lower side of the upper knife-bearing element is exposed to strong heat or heating by the roll strip. This creates unwanted stresses in the upper knife-bearing element, and in the same manner in the lower knife-bearing element.

FIG. 11 shows a front view of a drum shear 103 in accordance with the prior art known from CN 201271813Y. Therein, it can be seen that a roll strip 101 runs in a transport direction T between an upper knife drum 102.1 and a lower knife drum (not shown). A coolant supply device 114 is arranged above the upper knife drum 102.1, from which cooling water is sprayed downwards through a spray nozzle 14 onto the upper knife drum 102.1. In doing so, the surface of the drum itself or the surface of the knives M itself can be cooled. The disadvantage here is that the cooling water applied thereafter also arrives in a surface of the roll strip 101 and causes it to cool down.

For cooling the knife drums of a drum shear, it is also known that—if the drum shear is at a standstill—its knife drums are at least partially turned out of the rolling line and cooled with water sprayed from spray bars. Nevertheless, in the case of a drum shear that is equipped with three knives each along the circumference of its knife drums, it is not possible for its knife drums to be rotated out of the radiation area of the roll strip, because this would result in an unintentional cut of the roll strip. In addition, cooling water would thereby arrive onto the roll strip, which would result in a disadvantageous loss of heat.

Furthermore, to cool the knife drums of a drum shear, it is conceivable to drill cooling bores in the knife drums. This is known, for example, from RU 22 27 086 02. However, this is problematic with drum shears with three knives (per knife drum), because this can lead to “bore collisions” with other bores or channels, which are required to tension the knives. In addition, the realization of such an internal cooling is complex in terms of production technology and is therefore cost-intensive. Notwithstanding this, it is also problematic that the internal cooling of a knife drum cannot sufficiently reduce the stress level caused by the heating that arises through the adjacent roll strip. This has been established by the applicant for the present invention in corresponding FEM calculations.

Comparable disadvantages are equally known for other types of shears, for example gate shears or crank shears.

### SUMMARY

Accordingly, the invention is based on the object of optimizing the cooling for a knife-bearing element of a cross-cutting shear by simple means, preferably in the case of a drum shear, the knife drums of which are each equipped with three knives.

The preceding object is achieved by a device and a method as claimed.

A device in accordance with the present disclosure serves to cool at least one knife-bearing element of a cross-cutting shear installed in a rolling mill, for example in a hot rolling mill. Specifically, such device comprises at least one guard device, and a guide device on which the guard device can be movably guided and thus moved between a cooling position and a cutting position. The guard device is positioned in the cooling position between a knife-bearing element of the cross-cutting shear and a roll strip running continuously through the rolling mill, in such a manner that a side of the knife-bearing element opposite the roll strip is shielded by the guard device. In the cutting position, the guard device is spaced from a field of movement of the knife. In the case of a drum shear, it lies outside the knife circle, such that, when the knife drum rotates or when the roll strip is cut through, the guard device is not touched by such knife drum. The guide device is designed in the form of sliding guides, which are arranged on both sides of the roll strip, wherein the guard device is movably guided with its two end faces on the sliding guides, wherein the sliding guides are attached to the inner sides of the lateral stand frames of the cross-cutting shear. A first arc-shaped guide track and a second arc-shaped guide track are respectively formed in each of the sliding guides, wherein a path curve, which is defined by the arc-shaped guide tracks, points convexly outwards with respect to an adjacent knife drum, and wherein the guide tracks are arranged in a sliding guide in a partially overlapping manner.

In the same manner, the invention also provides for a method of cooling at least one knife-bearing element of a cross-cutting shear installed in a rolling mill, in particular in a hot rolling mill. Thereby, if the shear is at a standstill, at least one guard device is positioned in a cooling position between a knife-bearing element of the shear and a roll strip continuously running through the rolling mill, with the result that a side of this knife-bearing element opposite the roll strip is shielded by the guard device. The guard device is formed in two parts and comprises two shielding elements that are brought in mirror image from the inlet side of the roll strip and from the outlet side of the roll strip into the cooling position. The shielding elements are positioned adjacent to each other and thereby shield a lower side of the upper knife-bearing element from the roll strip. The shielding elements each have a trough area. Cooling water is continuously introduced into the trough areas while the shielding elements are in the cooling position; and the cooling water overflows side edges of the trough areas and flow laterally past the roll strip in a downward direction when the trough areas are fully flooded with cooling water.

The disclosure is based on the essential finding that the cooling of a knife-bearing element of a cross-cutting shear is already effected by introducing into the space or gap between the passing roll strip and the knife-bearing element adjacent thereto—in the cooling position—the at least one guard device, with which the side of the knife-bearing element that is adjacent to the hot roll strip is then physically shielded. In doing so, the use of cooling water is not absolutely necessary. As a result of such positioning of the guard device, the knife-bearing element is shielded or protected against direct heat radiation from the roll strip, such that heating of the knife-bearing element and the resulting stress level is reduced.

In the cooling position, the guard device can be expediently positioned between the upper knife-bearing element and the roll strip continuously running through the rolling mill. Accordingly, the lower side of the upper knife-bearing element is shielded from the roll strip with the assistance of the guard device. In other words, if the guard device is moved to the cooling position, the lower side of the upper knife-bearing element is no longer directly exposed to the heat radiation of the roll strip.

Further improved cooling can be achieved by the guard device having a trough area into which cooling water is introduced if the guard device is in the cooling position. This causes additional cooling of the guard device per se, which also reduces heat radiation in the direction of the upper knife drum. The cooling of the guard device can be further optimized by introducing the cooling water in its trough area in a permanent or circulating manner. This means that, after the trough area is completely flooded with cooling water, the cooling water then drains off laterally from the trough area and flows away downwards past the side of the roll strip and is then collected in a suitable manner.

In contrast to conventional cooling concepts, the present invention achieves the fact that, in connection with the cooling of a knife-bearing element of a cross-cutting shear, cooling water does not arrive on the roll strip and may not be necessary. If the trough area of the guard device, with which the lower side of the upper knife-bearing element is shielded in the cooling position, is additionally filled with cooling water, the overflowing cooling water is, as explained, suitably guided past the side of the roll strip and thus does not arrive on the surface of the roll strip. This reduces heat losses or costs that would otherwise be incurred in having to reheat the roll strip.

In contrast to conventional cooling concepts, the present invention achieves the fact that the entire temperature remains at a lower level due to the shielding of the knife-bearing element of the cross-cutting shear, and thus a temperature difference between areas of the knife-bearing element near the roll strip and areas of the knife-bearing element remote from the roll strip is kept as small as possible. This reduces internal stresses to a large extent without the need to apply cooling water. If additional cooling water is applied to the knife-bearing element and/or the shielding, no harmful internal stresses are created within the knife-bearing element due to the additional cooling. Thus, this shielding with one installation enables two advantageous effects.

In addition, it may be provided that, in the cooling position, that is, when the cross-cutting shear is at a standstill, an additional guard device is also positioned between the roll strip and the lower knife-bearing element. In the same manner as with the upper knife-bearing element, this leads to a shielding of the lower knife-bearing element from the roll strip and its heat radiation, such that a desired cooling for the lower knife-bearing element is achieved.

The guide device, on which the at least one guard is movably guided, serves to move the guard device into a cooling position if the shear is at a standstill, and into a cutting position if the knives of the shear are set in motion and the roll strip is cut accordingly. The guide device causes the guard(s) to move in such a manner that at no time during the transfer or swinging of the guard(s) from the cooling position to the cutting position does it overlap with the field of movement of the knife-bearing element. This means that the guard device does not touch the knife-bearing element both after reaching the cutting position and on the path there. This can be achieved, for example, by the guard device being moved by the guide device between the cooling position and the cutting position along a suitable path curve or line. In this manner, after reaching the cutting position, the guard device is also sufficiently far away from the knife-bearing element such that any pieces of strip flying around, which may be produced when cutting/separating and chopping the roll strip, do not touch or damage the guard device.

With regard to its at least one guard device and the associated guide device, the device is designed in such a manner that the guard device can be swiveled both into the cooling position and out into the cutting position without the guard device touching an adjacent knife-bearing element or its field of movement. For this purpose, it is particularly advantageous in the case of drum shears if the guard device is designed in two parts, specifically in the form of two shielding elements that—from the inlet side of the roll strip into the drum shear or from the outlet side of the roll strip out of the drum shear—are moved towards each other in mirror image in this inlet side or outlet side upon transfer to the cooling position. After reaching the cooling position, the two shielding elements are then positioned adjacent to each other such that they completely shield one side of a knife drum opposite the roll strip from the roll strip. Upon transfer to the cutting position, the two shielding elements are moved out of the inlet or outlet side of the drum shear, and then, after reaching the cutting position, move to a “parking position,” in which they are sufficiently far away from an adjacent knife drum.

For moving a guard device, for example in the form of the latter shielding elements, between the cooling position and the cutting position, an electric motor or a hydraulic cylinder may be used on each side (that is, on the inlet side and on the outlet side of the shear), if applicable using a four-jointed or multiple-jointed mechanism, through which a shielding element is in operative connection with or coupled to the drive (for example, an electric motor or a hydraulic cylinder).

The device in accordance with the present invention is characterized by a modular design of its components. Accordingly, this device can be easily maintained, assembled or disassembled. Furthermore, thanks to this modular design, it is also possible to retrofit existing shears with the device in accordance with the invention.

Cross-cutting within the meaning of the invention described above is understood to mean both the cropping of the beginning or end of a strip and the subdivision of the strip into sections of defined length by cross-cutting or chopping.

Knife-bearing elements within the meaning of the invention are those components of the shear that hold the cutting knives as such. This means, for example, the knife drums of a drum shear or the knife holders of a gate shear, etc.

The field of movement within the meaning of the invention is understood to be the area that a knife with its knife-bearing element passes through during the cutting movement itself. In the example of a drum shear, the field of movement is circular.

An embodiment of the invention is described in detail below, using the example of a drum shears arrangement on the basis of a schematically simplified drawing.

### BRIEF DESCRIPTION OF THE DRAWINGS

FIG. 1 is a perspective view of a device for cooling at least one knife-bearing element of a cross-cutting shear installed in a rolling mill.

FIG. 2 is a front view of the device of FIG. 1.

FIG. 3 is a partial perspective view of the device of FIG. 1, along the sectional view along line A-A of FIG. 2, in a cooling position.

FIG. 4 is a partial perspective view of the device of FIG. 1, along the sectional view along line A-A of FIG. 2, in a cutting position.

FIG. 5 is a perspective view of a sliding guide that is part of the device of FIG. 1.

FIG. 6 is a perspective view of a trough-shaped cover that is a part of the device of FIG. 1.

FIG. 7 is a perspective view of parts of the device of FIG. 1, comprising each of four sliding guides as shown in FIG. 5, and two trough-shaped covers as shown in FIG. 6 arranged between them.

FIGS. 8-10 are end face views of the device of FIG. 1 along line A-A of FIG. 2, each in different operating positions.

FIG. 11 is a front view of a drum shear in accordance with the prior art.

### DETAILED DESCRIPTION

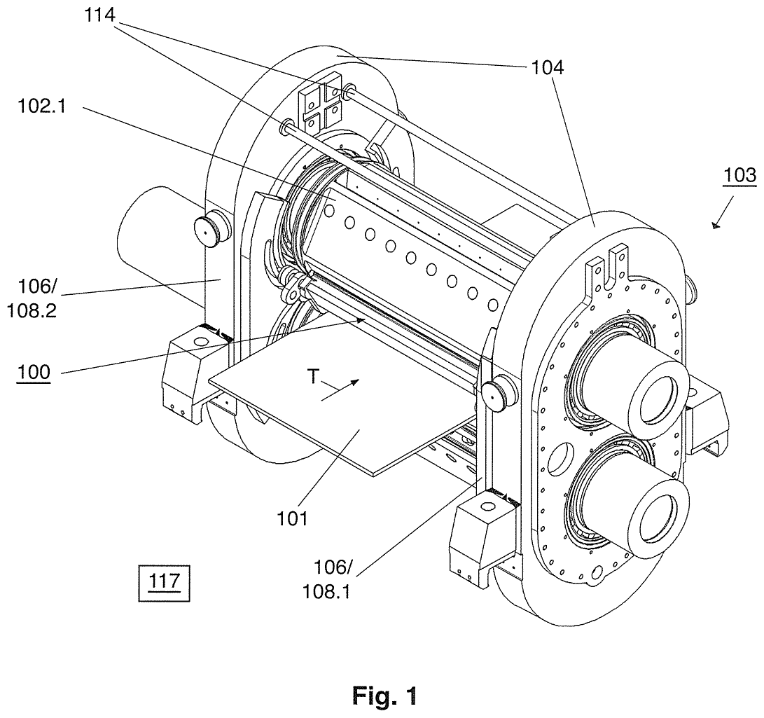

With reference to FIGS. 1 to 10, a preferred embodiment of a device 100 and its components, which serves to cool at least one knife drum of a drum shear 103, is explained below. At this point, it should be noted that identical features in the drawing are each provided with identical reference signs. The drawing is merely simplified and shown without scale in particular.

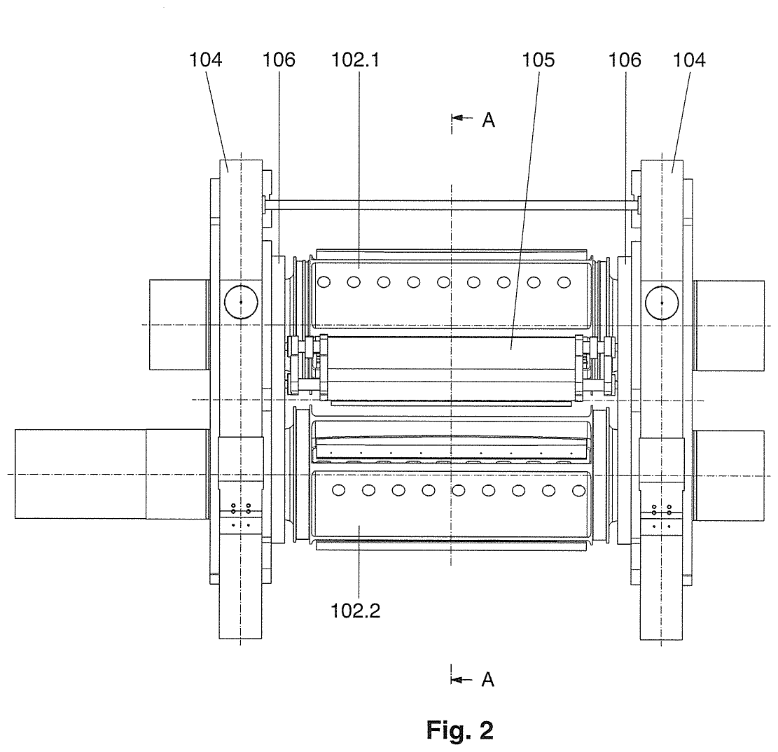

FIG. 1 shows a drum shear 103 in a perspective view, wherein such drum shear 103 is shown in FIG. 2 in a front view. A roll strip 101 runs through drum shear 103 between an upper knife drum, which serves as the knife-bearing element 102.1, and a lower knife drum, which serves as the knife-bearing element 102.2. In a known manner, such knife drums 102.1, 102.2 are at a standstill if the drum shear 103 is not being used to cut through the roll strip 101.

The drum shear 103 of FIG. 1 can be equipped with a device 100 in accordance with the invention, with which in particular the upper knife drum 102.1 of the drum shear 103 is cooled if the drum shear 103 is at a standstill. This device 100 will now be explained in detail with regard to its mode of operation and the associated components.

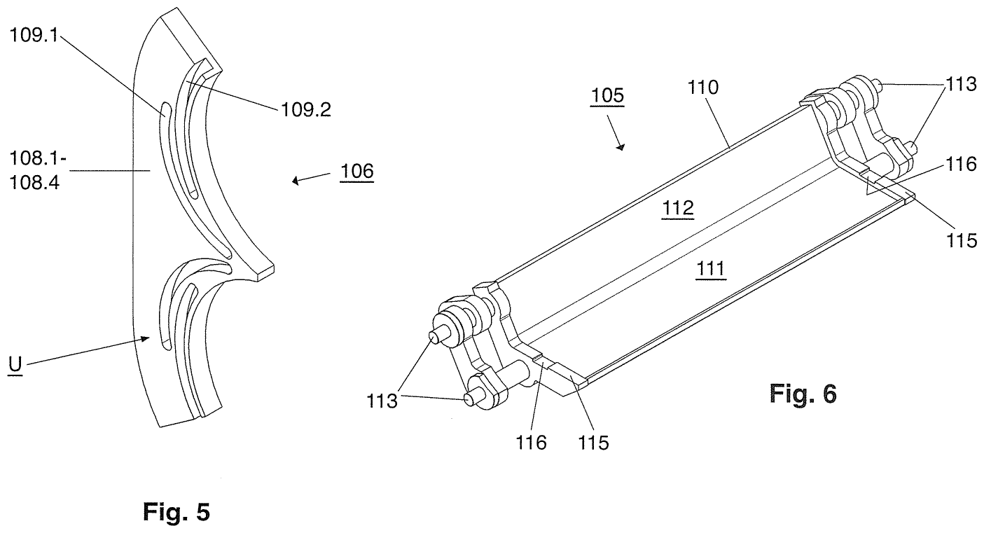

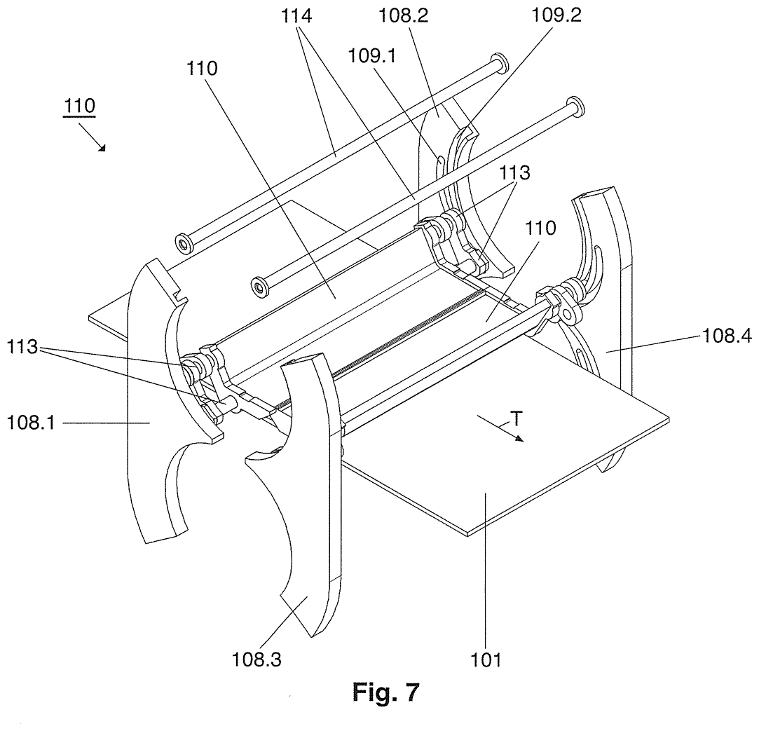

The device comprises at least one guard device 105 (see FIG. 2), which extends at least over the entire width of the roll strip 101 (see FIG. 1) and is movably guided between the lateral stand frames 104 of the drum shear 103 by means of a guide device 106. In detail, the guide device 106 comprises four sliding guides 108.1-108.4 (see FIG. 7), each of which is attached to an inner side of the stand frames 104. The perspective view of FIG. 5 illustrates that, in one surface of a sliding guide 108.1-108.4, a first arc-shaped guide track 109.1 and a second arc-shaped guide track 109.2 are formed, wherein such guide tracks 109.1, 109.2 partially overlap.

The guard device 105 is designed in two parts and comprises two shielding elements 110, one of which is shown in perspective in FIG. 6. A shielding element 110 comprises a trough area 111 and a wall area 112. In a cross-section along the width of the roll strip 101, the wall area 112 is arranged at an angle relative to the trough area 111. The significance of such angled arrangement of the wall area 112 relative to the trough area 111 is explained separately below.

Guide pins 113 adjacent to both the trough area 111 and the wall area 112 are attached on the side edges 115 of the shielding element 110. When a shielding element 110 is mounted on two guide tracks arranged opposite one another, such guide pins 113 are brought into engagement with the aforementioned guide tracks 109.1, 109.2, which are formed in a respective sliding guide 108.1-108.4. Accordingly, a shielding element 110 can be swiveled along these guide tracks 109.1, 109.2, which is explained below.

FIG. 7 shows the device 100 with its essential functional elements in perspective, for simplification without the drum shear 103. A shielding element 110 is arranged between the opposite sliding guides 108.1, 108.2—on the left in the picture area—wherein the lateral guide pins 113 of the shielding element 110 are in engagement with the guide tracks 109.1, 109.2 of the respective sliding guides 108.1, 108.2. In combination with the drum shear of FIG. 1, the sliding guides 108.1 and 108.2 are each provided in the inlet area of the drum shear 103, that is, in the picture area of FIG. 1, each to the left of the upper knife drum 102.1. In the same manner, between the opposite sliding guides 108.3, 108.4—in the picture area of FIG. 7 and FIG. 1, each on the right—an additional shielding element 110 is arranged, the lateral guide pins 113 of which also engage in the guide tracks 109.1, 109.2 of the sliding guides 108.3, 108.4.

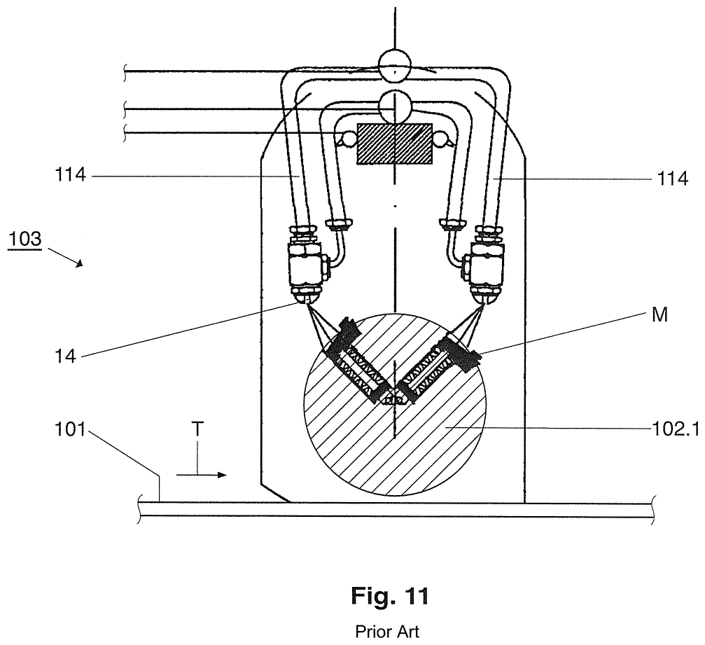

FIG. 7 illustrates the modular design of the device 100 in accordance with the invention. On the basis of this, it is possible to retrofit an existing drum shear 103, as shown for example in FIGS. 1 and 11, with the device 100 in accordance with the invention, wherein the knife drums 102.1, 102.2 do not require any modification. With regard to the sliding guides 108.1-108.4, it should be noted that these can be suitably attached to the inner sides of the stand frames 104 of the drum shear 103, if applicable also by means of retrofitting.

A combination of FIG. 7 with FIG. 1 (for example) makes it clear that the guard device 105 or its shielding elements 110 is/are wider than the roll strip 101.

The invention now functions as follows:

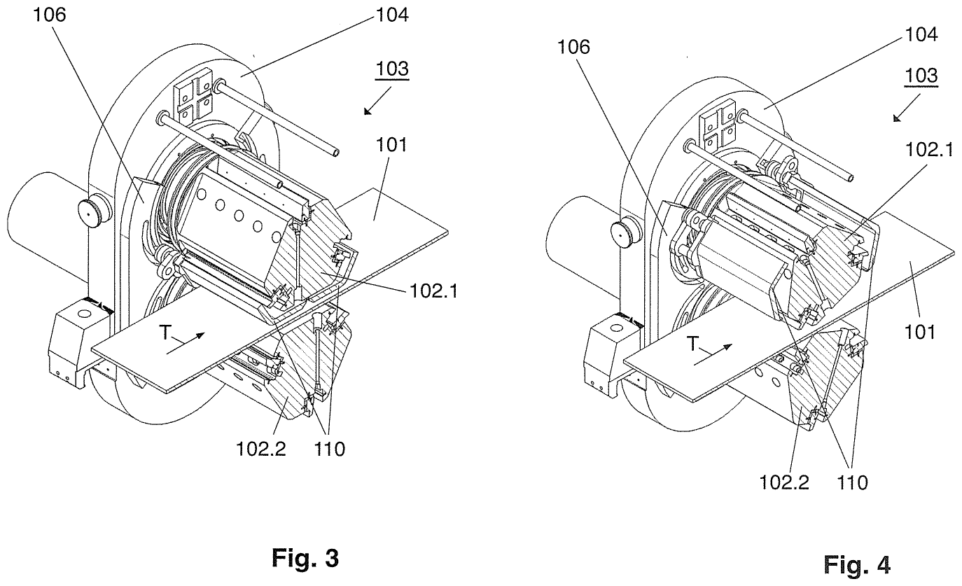

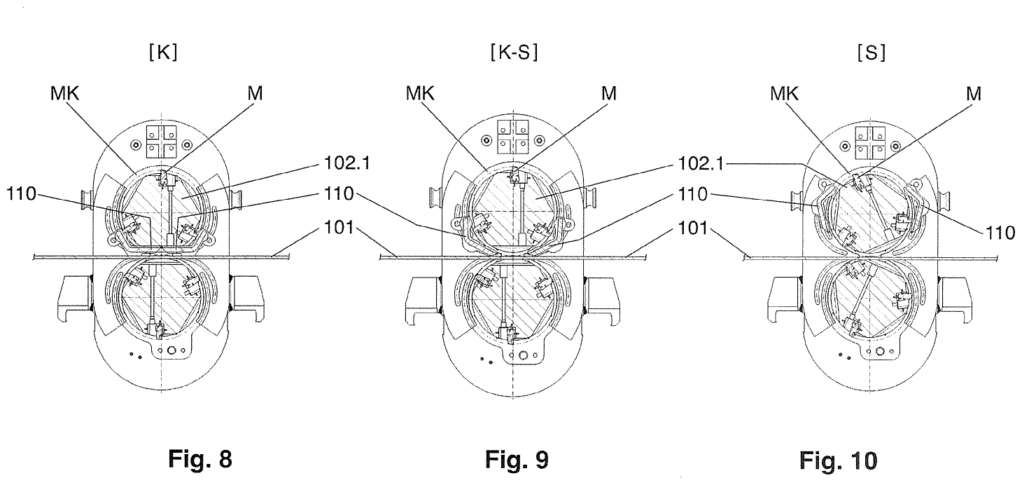

If the drum shear 103 is at a standstill and correspondingly its knife drums 102.1, 102.2. do not rotate, the shielding elements 110 are swiveled along the guide tracks 109.1, 109.2 of the respective sliding guides 108.1-108.4 into a cooling position. This corresponds to the illustration of the shielding elements 110 in FIG. 7, and also to the end face view of FIG. 8, which shows a sectional view along the line A-A of FIG. 2. Corresponding to this cooling position, the display of FIG. 8 is labeled “[K]”. For the further illustration of this cooling position, reference is also made to the perspective view in FIG. 3, which also shows a sectional view along line A-A of FIG. 2.

With regard to the cooling position [K], it should be understood that the shielding elements 110 are positioned between the upper knife drum 102.1 and the roll strip 101. Thus, the lower side of the upper knife drum 102.1 is shielded from the roll strip 101 by the two shielding elements 110, such that heat radiation from the roll strip 101 cannot directly affect the lower side of the upper knife drum 102.1.

The device 100 also includes a coolant supply device 114 in the form of spray bars arranged between the stand frames 104 of the drum shear 103 (see FIG. 1). From such spray bars 114, if the shielding elements 110 are swiveled into the cooling position, cooling water is sprayed against the inner surfaces of the wall areas 112, wherein the cooling water then arrives in the trough areas 111 of the shielding elements 110 at a reduced flow rate. In this respect, the wall areas 112 each act as a “baffle plate” in order to introduce the cooling water sprayed by the spray bars 114 with a calmed flow into the trough areas 111 of the shielding elements 110. For this purpose, the wall areas 112 are also arranged at an angle relative to the trough areas 111, as has already been explained in connection with FIG. 7.

The trough areas 111 can—in accordance with their designation—hold a certain volume of cooling water. Thus, the two shielding elements 110 are cooled and heat up less due to the heat radiation emitted by the roll strip 101. Indirectly, this also means that the upper knife drum 102.1 heats up less when the drum shear 103 is at a standstill.

As shown by the illustration of FIG. 6, on the side edges 115 of the shielding elements 110, adjacent to the trough area 111, outflow openings 116 are formed in each case, for example in the form of depressions on the edge of the trough area. In addition and/or as an alternative to this, it may be provided that the trough area 111 is penetrated by bores adjacent to the side edges 115. In any event, the effect of such outflow openings 116 or bores is that—after the trough area 111 has been completely “flooded” with cooling water—the cooling water can then escape from the side of the trough areas 111 and fall down past the side of the roll strip 101 and is disposed of in a suitable manner, for example through a scrap chute (not shown). Accordingly, if the shielding elements 110 are in the cooling position, cooling water is introduced or fed in a permanent or circulating manner into the trough areas 111 of the shielding elements 110 by means of a discharge through the spray bars 114, and then flows away downwards through the outflow openings 116, specifically laterally past the roll strip 101. This flow or falling down of the cooling water laterally past the roll strip 101 is ensured by the fact that the shielding elements 110 are each wider than the roll strip 101.

Before the drum shear 103 is set “in action” to cut through the roll strip 101, the shielding elements 110 are transferred from the cooling position [K] (see, for example, FIG. 8) to a so-called “cutting position,” which is shown, for example, in the illustration in FIG. 10, and is accordingly labeled [S]. When moving from the cooling position [K] to the cutting position [S], the shielding elements 110 with their guide pins 113 are moved or swiveled along a path curve that is defined by the arc-shaped guide tracks 109.1, 109.2 of the respective sliding guides 108.1-108.4. The course of such a swiveling from the cooling position [K] to the cutting position [S], or vice versa, is shown in the illustration in FIG. 9, which is accordingly labeled “[K-S]”.

The swiveling of the guard device 105 and its shielding elements 110 between the cooling position [K] and the cutting position [S] is achieved by suitable drive means, for example by hydraulic cylinders (not shown) that are arranged on the inlet side and on the outlet side of the drum shear 103 and that are each in operative connection with the shielding elements 110. In conjunction with such hydraulic cylinders, multiple jointed mechanisms can also be used to control the shielding elements 110. The actuation of such hydraulic cylinders, and also the supply of cooling water to the spray bars 114, can be controlled by a control device 117, which is simplified in FIG. 1 by a rectangle “117”.

Given the fact that the path curve defined by the respective arc-shaped guide track 109.1, 109.2 on the inlet side and outlet side of the drum shear 103 points convexly outwards, that is, away from the upper knife drum 102.1, in relation to the adjacent upper knife drum 102.1 (see FIG. 5), it is ensured that, when the shielding elements 110 are swiveled in the direction of the cutting position [S], the knife circle MK (see FIG. 8-10) of the upper knife drum 102.1 is not touched, and that there is no contact between the shielding elements 110 and the upper knife drum 102.1. It follows from this that at no time will there be a collision or contact between the shielding elements 110 and the upper knife drum 102.1 adjacent to them. A constantly sufficient distance between the shielding elements 110 during a move/swivel between the cooling position [K] and the cutting position [S] is also ensured by the angled arrangement of the wall area 112 relative to the trough area 111. The field of movement of the knife drum is not affected during cutting.

As soon as the shielding elements 110 have reached the cutting position, as shown in FIG. 10 and also in the perspective view of FIG. 4 (=sectional view line A-A of FIG. 2), the knife drums 102.1, 102.2 of the drum shear 103 can be set in rotation in order to cut the roll strip 101. In this respect, it is additionally pointed out that the shielding elements 110 have a sufficient distance from the roll strip 101 in the cutting position and are thus protected from any pieces of the cut roll strip 101 flying around in an uncontrolled manner.

It is understood that the supply of cooling water, which in the cooling position is spread by the spray bars 114 (as explained) and fed into the trough areas 111 of the shielding elements 110, is stopped before the shielding elements 110 are swiveled from the cooling position [K] to the cutting position [S]. The shielding elements 110 are only swiveled out of the cooling position [K] and moved away from each other after all the cooling water from the trough areas 111 has been discharged downwards through the outflow openings 116, laterally past the roll strip 101. This prevents cooling water from arriving in the roll strip 101 when the shielding elements 110 are swiveled to the cutting position [S].

After completion of a cutting operation, if the rolling process for the roll strip 101 is continued in the usual manner and the drum shear 103 is brought to a standstill again, the shielding elements 110 are swiveled from the cutting position [S] back to the cooling position [K], in accordance with a sequence of FIG. 10, FIG. 9 and FIG. 8. After the shielding elements 110 have reached the cooling position [K], cooling water is again sprayed through the spray bars 114, such that the cooling water arrives in the trough areas 111.

The device described above is particularly suitable for cooling the upper knife drum 102.1 of a drum shear 103, if a total of three knives M (see FIG. 8-FIG. 10) are attached to it.

As already explained elsewhere, optional cooling or shielding of the lower knife drum 102.2 is also possible by inserting an additional (not shown) guard device into the space between the roll strip 101 and the lower knife drum 102.2 when the drum shear 103 is at a standstill. Such an additional guard device for shielding the lower knife drum 102.2 can also be designed in the form of two separate shielding elements, which are movably guided along the guide tracks formed in a respective sliding guide (see lower area of FIG. 5: indicated there by the arrow “U”) and thus—in the same manner as the shielding elements 110 for the upper knife drum 102.1—can be swiveled on a path curve between the cooling position and the cutting position.

In addition to the design shown in the drawing, it is also possible to use the device 100 in accordance with the invention with a drum shear that is only equipped with two knives per knife drum.

Similarly, the invention can also be applied to other cross-cutting shears, for example gate shears, crank shears, etc.

### LIST OF REFERENCE SIGNS

100 Device
101 Roll strip
102.1/102.2 Upper/lower knife drum as knife-bearing element
103 Drum shear
104 Stand frame (of the drum shear 103)
105 Guard device
106 Guide device
108.1-108.4 Sliding guide(s)
109.1 First arched guide track
109.2 Second arc-shaped guide track
110 Shielding element(s)
111 Trough area (of a shielding element 110)
112 Wall area (of a shielding element 110)
113 Guide pin
114 Coolant supply device/spray bar
115 Side edge (of a shielding element 110)
116 Outlet opening (on or in a trough area 111)
117 Control device
[K] Cooling position
[K-S] Transition from cooling position to cutting position, and vice versa
M Knife
MK Field of movement/knife circle (of a knife drum 102.1, 102.2),
[S] Cut position
T Transport direction of the roll strip 101/direction of strip travel

1.-19. (canceled)

20. A device (100) for cooling at least one knife-bearing element (102.1, 102.2) of a cross-cutting shear (103) installed in a rolling mill, in particular in a hot rolling mill, comprising:
a guard device (105); and
a guide device (106) on which the guard device (105) is movably guided and can thus be moved between a cooling position (K) and a cutting position (S),
wherein the guard device (105) is positioned in the cooling position (K) between a knife-bearing element (102.1, 102.2) and a roll strip (101) which continuously runs through the rolling mill, such that a side of the knife-bearing element (102.1, 102.2) opposite the roll strip (101) is shielded by the guard device (105),
wherein the guard device (105) in the cutting position (S) is spaced apart from a field of movement (MK) of the knife-bearing element (102.1, 102.2), such that the guard device (105) is not touched by such knife-bearing element (102.1, 102.2) during movement of the knife-bearing element (102.1, 102.2) or during cutting of the roll strip (101),
wherein the guide device (106) is designed in form of sliding guides (108.1-108.4), which are arranged on both sides of the roll strip (101),
wherein the guard device (105) is movably guided with its two end faces on the sliding guides (108.1-108.4),
wherein the sliding guides (108.1-108.4) are attached to inner sides of lateral stand frames (104) of the cross-cutting shear (103),
wherein a first arc-shaped guide track (109.1) and a second arc-shaped guide track (109.2) are respectively formed in each of the sliding guides (108.1-108.4),
wherein a path curve, which is defined by the arc-shaped guide tracks (109.1, 109.2), points convexly outwards with respect to an adjacent knife drum (102.1, 102.2), and
wherein the guide tracks (109.1, 109.2) are arranged in a sliding guide (108.1-108.4) in a partially overlapping manner.

21. The device (100) according to claim 20,
wherein a width of the guard device (105) transverse to a transport direction (T) of the roll strip (101) corresponds at least to a width of the knife-bearing element (102.1, 102.2).

22. The device (100) according to claim 20,
wherein a width of the guard device (105) transverse to a transport direction (T) of the roll strip (101) is greater than a width of the knife-bearing element (102.1, 102.2).

23. The device (100) according to claim 20,
wherein a drive device is in operative connection with the guard device (105), in order to move the guard device (105) along the guide device (106) into the cooling position (K) or into the cutting position (S).

24. The device (100) according to claim 23,
wherein the drive device comprises an electric motor or a hydraulic cylinder that is in operative connection with the guard device (105), in order to move the guard device (105) along the guide device (106) into the cooling position (K) or into the cutting position (S).

25. The device according to claim 23,
wherein the drive device comprises a four-jointed or multiple-jointed mechanism, through which the drive device is coupled to the guard device (105).

26. The device (100) according to claim 20,
wherein the guard device (105) is formed in two parts and comprises two shielding elements (110) that—viewed from an inlet side of the roll strip (101) and from an outlet side of the roll strip (101) into or from the cross-cutting shear (103)—are movable for transfer into the cooling position (K) in mirror image in the inlet side or outlet side in such a manner that the shielding elements (110) are positioned adjacent to one another in the cooling position (K) and thereby shield a side of the knife-bearing element (102.1, 102.2) opposite the roll strip (101) from the roll strip (101).

27. The device (100) according to claim 26,
wherein each of the two shielding elements (110) has a trough area (111) and a wall area (112),
wherein the wall area (112) is arranged at an angle relative to the trough area (111) in cross-section along a width of the roll strip (101).

28. The device (100) according to claim 27,
wherein lateral guide pins (113) are attached to side edges (115) of a shielding element (110) both adjacent to the trough area (111) and adjacent to the wall area (112), which guide pins are in engagement with the arc-shaped guide tracks (109.1, 109.2).

29. The device (100) according to claim 26,
wherein the guard device (105) is positioned in the cooling position (K) between an upper knife-bearing element (102.1) of the cross-cutting shear (103) and the roll strip (101) which runs continuously through the rolling mill, such that a lower side of the upper knife-bearing element (102.1) is shielded from the roll strip (101) by the guard device (105).

30. The device (100) according to claim 29,
further comprising a coolant supply device (114), by means of which a coolant can be introduced from above into trough areas (111) of the shielding elements (110).

31. The device (100) according to claim 30,
wherein at least one outflow opening (116) is formed on a side edge of the trough area (111) of a shielding element (110), through which outflow opening the coolant can emerge downwards in a targeted manner.

32. The device according to claim 20,
wherein the cross-cutting shear (103) is a drum shear, and
wherein a knife-bearing element is formed as a knife drum of the drum shear.

33. The device according to claim 20,
wherein the cross-cutting shear (103) is a gate shear.

34. The device according to claim 20,
wherein the cross-cutting shear (103) is a crank shear.

35. A method for cooling a knife-bearing element (102.1, 102.2) of a cross-cutting shear (103) installed in a rolling mill, in particular in a hot rolling mill, comprising:
arranging, when the cross-cutting shear (103) is at a standstill, at least one guard device (105) in a cooling position (K) between a knife-bearing element (102.1, 102.2) of the cross-cutting shear (103) and a roll strip (101) which continuously runs through the rolling mill, such that a side of the knife-bearing element (102.1, 102.2) opposite the roll strip (101) is shielded by the guard device (105),
wherein the guard device (105) is formed in two parts and comprises two shielding elements (110) that are brought in mirror image from an inlet side of the roll strip (101) and from an outlet side of the roll strip (101) into the cooling position (K), in which the shielding elements (110) are positioned adjacent to each other and thereby shield a lower side of the knife-bearing element (102.1) from the roll strip (101),
wherein the shielding elements (110) each have a trough area (111);
continuously introducing cooling water into the trough areas (111) while the shielding elements (110) are in the cooling position (K); and
allowing the cooling water to overflows side edges (115) of the trough areas (111) and flow laterally past the roll strip (101) in a downward direction when the trough areas (111) are fully flooded with cooling water.

36. The method according to claim 35,
wherein the guard device (105) is positioned between an upper knife-bearing element (102.1) of the cross-cutting shear (103) and the roll strip (101) which continuously runs through the rolling mill.
